(19) United States
(12) Patent Application Publication
(10) Pub. No.: US 2008/0118791 A1
(43) Pub. Date: May 22, 2008

(54) FUEL CELL SYSTEM AND CONTROL METHOD THEREFOR

(75) Inventors: Takashi ITO, Shizuoka (JP); Arato TAKAHASHI, Shizuoka (JP)

Correspondence Address: YAMAHA HATSUDOKI KABUSHIKI KAISHA;C/O KEATING & BENNETT, LLP, 8180 GREENSBORO DRIVE, SUITE 850, MCLEAN, VA, 22102, US

(73) Assignee: Yamaha Hatsudoki Kabushiki Kaisha, Iwata-shi (JP)

(21) Appl. No.: 11/940,456

(22) Filed: Nov. 15, 2007

(30) Foreign Application Priority Data
Nov. 16, 2006 (JP) 2006-310230

(51) Int. Cl. H01M 8/04

(52) U.S. Cl. 429/13; 429/22; 429/34

(57) ABSTRACT

A fuel cell system that is capable of stabilizing an output from a fuel cell, and a control method therefor, includes a cell stack which includes a plurality of fuel cells, pipes for circulating a supply of aqueous methanol solution to the cell stack, an aqueous solution tank, an aqueous solution pump, and a CPU which controls the fuel cell system. The CPU sets a waiting time from a start of circulating a supply of aqueous methanol solution to a start of tapping of electricity based on an elapsed time from the previous power generation shutdown. After a lapse of the waiting time, the CPU turns on an ON/OFF circuit, and tapping of electricity is started from the cell stack via an electric circuit.

### BACKGROUND OF THE INVENTION

1. Field of the Invention

The present invention relates to fuel cell systems and a control method therefor, and more specifically, to a fuel cell system in which aqueous fuel solution is supplied directly to the fuel cell, and to a control method therefor.

2. Description of the Related Art

JP-A 2005-150106 discloses a fuel cell system in which aqueous fuel solution is supplied directly to the fuel cell. In such a fuel cell system as the above, tapping of electricity is started simultaneously with a start of supplying the aqueous fuel solution and oxygen-containing gas (air) to the fuel cell. In other words, tapping of electricity from the fuel cell is started as soon as the fuel cell starts power generation.

Generally, in such a fuel cell system as described above, it is known that the aqueous fuel solution moves to the cathode side of the fuel cell in a crossover phenomenon, and that the aqueous fuel solution evaporates.

In such a fuel cell system as described above, the extent of crossover and evaporation of the aqueous fuel solution differs from place to place, resulting in non-uniform (uneven) concentration of the aqueous fuel solution when power generation is stopped. Thus, output from the fuel cell is unstable when power generation is started the next time.

In a small fuel cell system, this was not a problem because the amount of aqueous fuel solution circulating in the system is small, and therefore the concentration non-uniformity is naturally reduced to a negligible extent by diffusion. However, when using a relatively large fuel cell system, the amount of aqueous fuel solution circulating in the system is also large, and as the amount of the aqueous fuel solution is large, it becomes difficult to reduce the concentration non-uniformity once the concentration non-uniformity has occurred. If power generation is performed without correcting the concentration non-uniformity, an electrolyte film deteriorates at an accelerated pace, and shortens the life of the fuel cell.

### SUMMARY OF THE INVENTION

In order to overcome the problems described above, preferred embodiments of the present invention provide a fuel cell system capable of stabilizing the output from the fuel cell, and provide a control method therefor.

According to a preferred embodiment of the present invention, a fuel cell system includes a fuel cell, a circulation device arranged to circulate a supply of aqueous fuel solution to the fuel cell, a tapping device arranged to take electricity out of the fuel cell, and a first controller arranged to control the tapping device so as to start tapping electricity from the fuel cell after the circulation device starts circulating the supply of aqueous fuel solution.

According to another preferred embodiment of the present invention, a control method for a fuel cell system includes a first step of starting circulating a supply of aqueous fuel solution to a fuel cell, and a second step of starting tapping of electricity from the fuel cell after the first step.

According to a preferred embodiment of the present invention, tapping of electricity from the fuel cell is started after circulating the supply of aqueous fuel solution is started, whereby it becomes possible to agitate the aqueous fuel solution before starting the tapping of electricity, and to reduce concentration non-uniformity in the aqueous fuel solution. By reducing the concentration non-uniformity in the aqueous fuel solution and then starting the tapping of electricity as described, it becomes possible to stabilize the fuel cell's output. Since it is possible to generate power in a state where the concentration non-uniformity is reduced, it is now possible to reduce deterioration of the electrolyte film and to increase the life of the fuel cell.

Preferably, the fuel cell system further includes a first time-measuring device arranged to measure a time since the circulation device started circulating the supply of aqueous fuel solution, and the first controller controls the tapping device based on a result of time measured by the first time-measuring device. In this case, the timing for the tapping device to start tapping electricity is controlled based on the time since circulating the supply of aqueous fuel solution was started. The concentration of the aqueous fuel solution becomes more uniform as circulating the supply of the aqueous fuel solution continues, i.e., as the aqueous fuel solution is agitated for a longer time. Therefore, the timing for starting the tapping of electricity can be controlled easily based on the time since circulating the supply was started.

Further, preferably, the fuel cell system further includes a setting device arranged to set a waiting time from a start of circulating the supply by the circulation device to a start of tapping of electricity by the tapping device, based on information regarding concentration non-uniformity of the aqueous fuel solution before circulating the supply. With this arrangement, the first controller controls the tapping device so as to start tapping electricity from the fuel cell after a result of time measured by the first time-measuring device has exceeded the waiting time. In this case, the waiting time from the start of circulating the supply to the start of tapping of electricity is set based on the information regarding the concentration non-uniformity of the aqueous fuel solution before circulating the supply. Thereafter, when the time since the start of circulating the supply has exceeded the waiting time, then tapping of electricity is started from the fuel cell. This makes it possible to start tapping electricity from the fuel cell at a timing according to the concentration non-uniformity of the aqueous fuel solution.

Further, preferably, the fuel cell system includes an instruction device arranged to issue a power generation start command of the fuel cell, and a second-time measuring device arranged to measure a time from a previous power generation shutdown to a current power generation starting command issued by the instruction device. With this arrangement, the setting device sets the waiting time based on the information regarding the concentration non-uniformity defined by a result of time measured by the second-time measuring device. The concentration difference (non-uniformity) in the aqueous fuel solution at different locations in the circulation device varies depending on the time for which power generation is stopped. Therefore, the amount of time necessary for bringing the aqueous fuel solution to a substantially uniform concentration by circulating the supply varies depending on the time for which power generation is stopped. For this reason, the waiting time is based on the amount of time from the previous power generation shutdown to the current power generation starting command, whereby it becomes possible to start tapping electricity from the fuel cell at a timing according to the concentration non-uniformity of the aqueous fuel solution.

Preferably, the tapping device includes an electric circuit arranged to provide an electric connection between the fuel cell and a load and a switching device provided on the electric circuit arranged to select from a state where an electric current can flow between the fuel cell and the load and a state where an electric current cannot flow. With this arrangement, the first controller controls the switching device so as to start tapping electricity from the fuel cell after the circulation device starts circulating the supply. By controlling the switching device so that electricity can flow through a path which connects the fuel cell and the load, after circulating the supply of aqueous fuel solution is started, it becomes possible to agitate the aqueous fuel solution before tapping of electricity is started, and thereby to reduce the concentration non-uniformity in the aqueous fuel solution.

Preferably, the fuel cell system further includes a water supply device arranged to supply water to the circulation device; and a second controller arranged to control the water supply device so as to supply the water to the circulation device before electricity is tapped from the fuel cell. It is generally known that in order to prevent shortage of the aqueous fuel solution which is to be supplied to the fuel cell, water is supplied (added) to the circulation device before starting circulating the supply. In this case, the concentration non-uniformity in the aqueous fuel solution increases, and the output from the fuel cell becomes more unstable if circulating the supply and tapping of electricity are started simultaneously. In a preferred embodiment of the present invention, water is added to the circulation device, then circulating the supply of the aqueous fuel solution is performed, and thereafter electricity is tapped from the fuel cell. Or, circulating the supply of the aqueous fuel solution is started, and then water is added while circulating the supply is underway, and then electricity is tapped from the fuel cell. Therefore, it is possible to stabilize the fuel cell's output whether the addition of water is made before or after circulating the supply of the aqueous fuel solution is started.

Further, preferably, the fuel cell system further includes a fuel supply device arranged to supply the circulation device with fuel of a higher concentration than the aqueous fuel solution, a water supply amount obtaining device arranged to obtain an amount of the water supplied to the circulation device by the water supply device, and a third controller arranged to control the fuel supply device so as to supply the fuel to the circulation device based on the supplied amount of water obtained by the water supply amount obtaining device, before electricity is tapped from the fuel cell. In this case, it is possible to supply the circulation device with an amount of fuel according to the supplied amount of water, and to reduce the concentration change in the aqueous fuel solution caused by the water supplied to the circulation device. This makes it possible to further stabilize the fuel cell's output.

Further, preferably, the fuel cell system includes a fuel supply device arranged to supply the circulation device with fuel of a higher concentration than the aqueous fuel solution, and a third controller arranged to control the fuel supply device so as to supply the fuel to the circulation device before electricity is tapped from the fuel cell. It is generally known that in order to raise the temperature of the fuel cell quickly, fuel is supplied (added) to the circulation device before starting circulating the supply, whereby the concentration of the aqueous fuel solution is increased. In this case, the concentration non-uniformity in the aqueous fuel solution increases, and the output from the fuel cell becomes more unstable if circulating the supply and tapping of electricity are started simultaneously. In a preferred embodiment of the present invention, fuel is added to the circulation device, then circulating the supply of the aqueous fuel solution is performed, and thereafter electricity is tapped from the fuel cell. Or, circulating the supply of the aqueous fuel solution is started, and then fuel is added while circulating the supply is underway, and then electricity is tapped from the fuel cell. Therefore, it is possible to stabilize the fuel cell's output whether the addition of fuel is made before or after circulating the supply of aqueous fuel solution is started.

Generally, in a relatively large fuel cell system which has an output capacity not smaller than about 100 W, it has been difficult to reduce the concentration non-uniformity in the aqueous fuel solution once the concentration non-uniformity has occurred. However, according to a preferred embodiment of the present invention, the concentration non-uniformity can be reduced. Therefore, a preferred embodiment of the present invention can be used suitably for a fuel cell system which has an output capacity not smaller than about 100 W.

Desirably, transportation equipment should be able to operate stably. The fuel cell system according to a preferred embodiment of the present invention is capable of stabilizing the fuel cell's output, quickly achieving and maintaining a high output, quickly driving the system components, and hence the transportation equipment more stably. Therefore, the fuel cell system according to a preferred embodiment of the present invention can be used suitably for transportation equipment.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a left side view of a motorbike as a preferred embodiment of the present invention.

FIG. 2 is a system diagram showing piping in a fuel cell system of a preferred embodiment of the present invention.

FIG. 3 is a block diagram showing an electric configuration of the fuel cell system according to a preferred embodiment of the present invention.

FIG. 4 is a flowchart showing an example of the operation of the fuel cell system according to a preferred embodiment of the present invention.

FIG. 5 is a flowchart showing an example of the liquid amount adjusting operation.

FIG. 6 is a graph showing timecourse changes of output, etc., in a comparative example, in a case where power generation was started when the aqueous methanol solution was at a temperature close to ambient temperature.

FIG. 7 is a graph showing timecourse changes of output, etc., in a fuel cell system according to a preferred embodiment of the present invention, in a case where power generation was started when the aqueous methanol solution was at a temperature close to ambient temperature.

FIG. 8 is a graph showing timecourse changes of output, etc., in the comparative example, in a case where power generation was started when the aqueous methanol solution was warm.

FIG. 9 is a graph showing timecourse changes of output, etc., in the fuel cell system according to a preferred embodiment of the present invention, in a case where power generation was started when the aqueous methanol solution was warm.

FIG. 10 is a flowchart of another operation example of the fuel cell system according to a preferred embodiment of the present invention.

### DETAILED DESCRIPTION OF PREFERRED EMBODIMENTS

Hereinafter, preferred embodiments of the present invention will be described with reference to the drawings.

The present preferred embodiment preferably is a fuel cell system 100 that is provided in a motorbike 10 as an example of transportation equipment.

The description will first cover the motorbike 10. It is noted that the terms left and right, front and rear, up and down as used in the present preferred embodiment of the present invention are determined from the normal state of riding, i.e., as viewed by the driver sitting on the driver's seat of the motorbike 10, with the driver facing toward a handle 24.

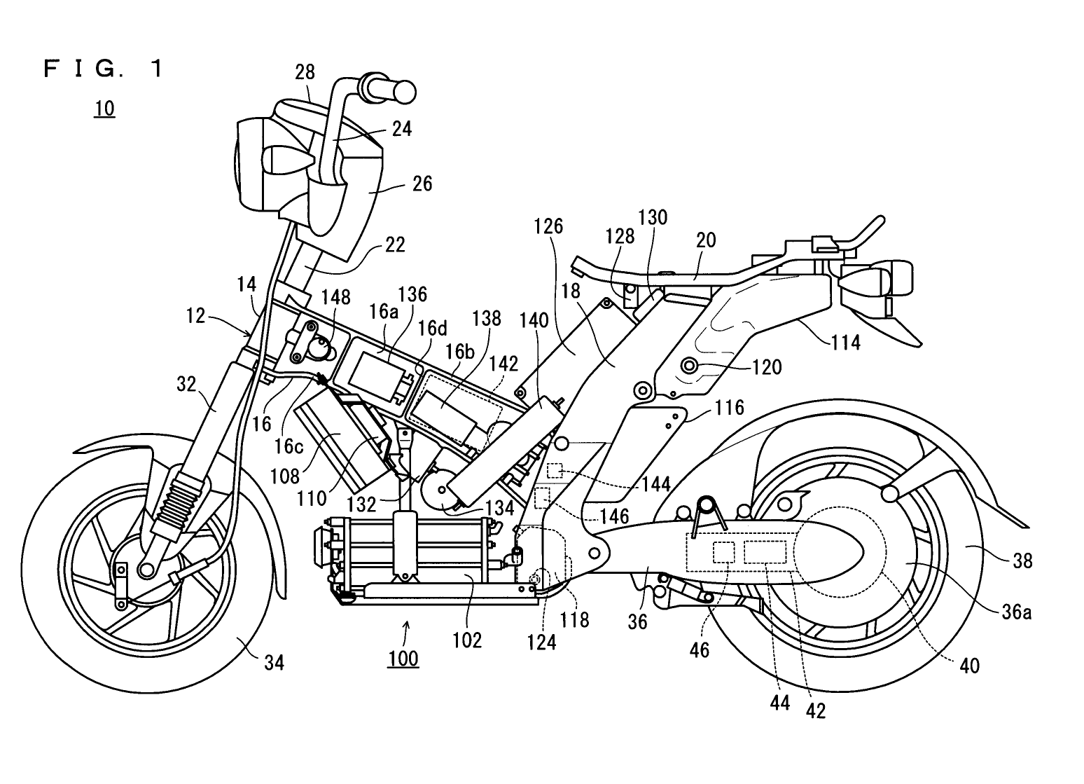

Referring to FIG. 1, the motorbike 10 preferably includes a vehicle frame 12. The vehicle frame 12 has a head pipe 14, a front frame 16 which has an I-shaped vertical section and extends in a rearward and downward direction from the head pipe 14, and a rear frame 18 which is connected with a rear end of the front frame 16 and rises in a rearward and upward direction.

The front frame 16 preferably includes a plate member 16a which has a width in the vertical direction and extends in a rearward and downward direction, substantially perpendicularly to the lateral directions of the vehicle; flanges 16b, 16c which are located respectively at an upper end edge and a lower end edge of the plate member 16a, extend in a rearward and downward direction and have a width in the lateral directions; and reinforcing ribs 16d protruding from both surfaces of the plate member 16a. The reinforcing ribs 16d and the flanges 16b, 16c define storage walls, providing compartments on both surfaces of the plate member 16a defining storage spaces for components of the fuel cell system 100 to be described later.

The rear frame 18 preferably includes a pair of left and right plate members each having a width in the front and rear directions, extending in a rearward and upward direction, and sandwiching a rear end of the front frame 16. The pair of plate members of the rear frame 18 have their upper end portions provided with seat rails 20 fixed thereto, for installation of an unillustrated seat. Note that FIG. 1 shows the left plate member of the rear frame 18.

A steering shaft 22 is pivotably inserted in the head pipe 14. A handle support 26 is provided at an upper end of the steering shaft 22, to which a handle 24 is fixed. The handle support 26 has an upper end provided with a display/operation board 28.

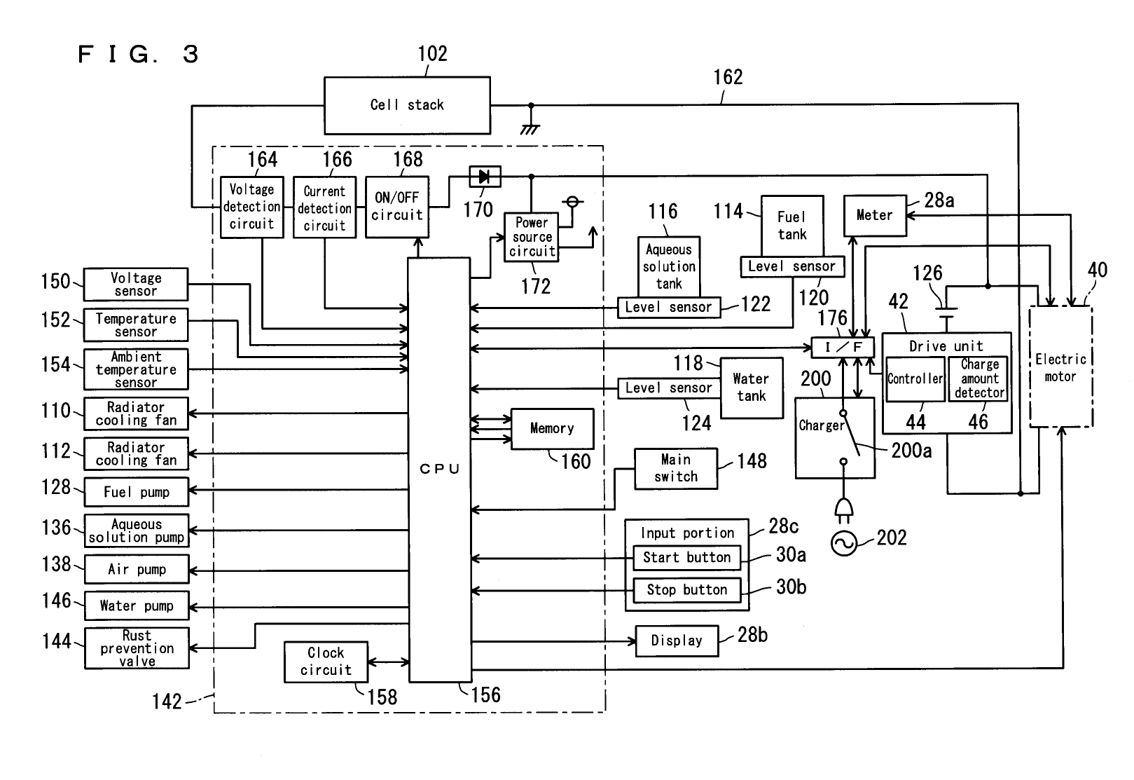

Referring also to FIG. 3, the display/operation board 28 is an integrated dashboard including a meter 28a for measuring and displaying various data concerning an electric motor 40 (to be described later); a display 28b provided by, e.g., a liquid crystal display for providing the driver with a variety of information concerning the ride; and an input portion 28c for inputting a variety of commands and data. The input portion 28c includes a start button 30a for issuing a power generation start command of a fuel cell stack (hereinafter simply called cell stack) 102 and a stop button 30b for issuing a power generation stop command of the cell stack 102.

As shown in FIG. 1, a pair of left and right front forks 32 extend from a bottom end of the steering shaft 22. Each of the front forks 32 includes a bottom end supporting a front wheel 34 rotatably.

The rear frame 18 includes a lower end which pivotably supports a swing arm (rear arm) 36. The swing arm 36 has a rear end 36a incorporating an electric motor 40 of an axial gap type for example, which is connected with the rear wheel 38 to rotate the rear wheel 38. The swing arm 36 also incorporates a drive unit 42 which is electrically connected with the electric motor 40. The drive unit 42 includes a motor controller 44 arranged to control the rotating drive of the electric motor 40, and a charge amount detector 46 for detecting the amount of charge in the secondary battery 126 (to be described later).

The motorbike 10 as described is equipped with a fuel cell system 100, with its constituent members being disposed along the vehicle frame 12. The fuel cell system 100 generates electric energy for driving the electric motor 40 and other system components.

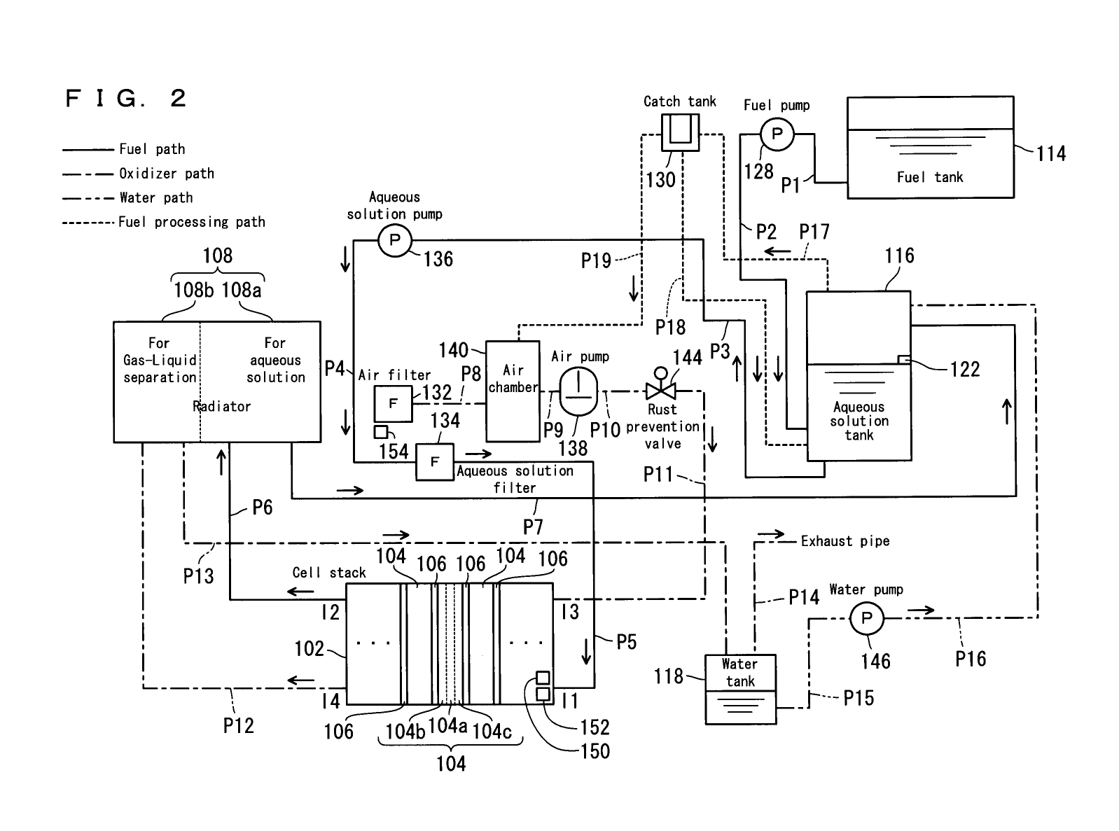

Hereinafter, the fuel cell system 100 will be described with reference to FIG. 1 and FIG. 2.

The fuel cell system 100 is preferably a direct methanol fuel cell system which uses methanol (an aqueous solution of methanol) directly without reformation, for generation of electric energy (power generation).

The fuel cell system 100 includes the cell stack 102. As shown in FIG. 1, the cell stack 102 is suspended from the flange 16c, and is disposed below the front frame 16.

As shown in FIG. 2, the cell stack 102 includes a plurality of fuel cells (individual fuel cells) 104 layered (stacked) in alternation with separators 106. Each fuel cell 104 is capable of generating electric power through electrochemical reactions between hydrogen ions based on methanol and oxygen. Each fuel cell 104 in the cell stack 102 includes an electrolyte film 104a, such as a solid polymer film, for example, and a pair of an anode (fuel electrode) 104b and a cathode (air electrode) 104c opposed to each other, with the electrolyte film 104a in between. The anode 104b and the cathode 104c each preferably include a platinum catalyst layer provided on the side closer to the electrolyte film 104a.

As shown in FIG. 1, a radiator unit 108 is disposed below the front frame 16 and above the cell stack 102.

As shown in FIG. 2, the radiator unit 108 includes integrally therein, a radiator 108a for aqueous solution and a radiator 108b for gas-liquid separation. On a back side of the radiator unit 108, there is a fan 110 provided to cool the radiator 108a, and there is another fan 112 (see FIG. 3) provided to cool the radiator 108b. In FIG. 1, the radiators 108a and 108b are disposed side by side, with one on the left-hand side and the other on the right-hand side, and the figure shows the fan 110 for cooling the left-hand side radiator 108a.

A fuel tank 114, an aqueous solution tank 116 and a water tank 118 are disposed in this order from top to down, between the pair of plate members in the rear frame 18.

The fuel tank 114 contains a methanol fuel (high concentration aqueous solution of methanol) having a high concentration level (containing methanol at approximately 50 wt %, for example) which is used as fuel for the electrochemical reaction in the cell stack 102. The aqueous solution tank 116 contains aqueous methanol solution, which is a solution of the methanol fuel from the fuel tank 114 diluted to a suitable concentration (containing methanol at approximately 3 wt %, for example) for the electrochemical reaction in the cell stack 102. The water tank 118 contains water which is produced in associated with power generation in the cell stack 102.

The fuel tank 114 is provided with a level sensor 120 while the aqueous solution tank 116 is provided with a level sensor 122, and the water tank 118 is provided with a level sensor 124. The level sensors 120, 122 and 124 are float sensors each having an unillustrated float for example, and detect the height of liquid (liquid level) in the respective tanks by the position of the moving float.

In front of the fuel tank 114 and above the front frame 16 is the secondary battery 126. The secondary battery 126 stores the electric power from the cell stack 102, and supplies the electric power to the electric components in response to commands from a controller 142 (to be described later). Above the secondary battery 126, a fuel pump 128 is disposed. Further, a catch tank 130 is disposed in front of the fuel tank 114, i.e., above and behind the secondary battery 126.

An air filter 132 is disposed in a space surrounded by the front frame 16, the cell stack 102 and the radiator unit 108 for removing impurities such as dust contained in the air. Behind and below the air filter 132, an aqueous solution filter 134 is disposed.

An aqueous solution pump 136 and an air pump 138 are housed in the storage space on the left side of the front frame 16. On the left side of the air pump 138 is an air chamber 140. The controller 142, a rust prevention valve 144 and a water pump 146 are disposed in the storage space on the right side of the front frame 16.

A main switch 148 is provided in the front frame 16, penetrating the storage space in the front frame 16 from right to left. Turning on the main switch 148 provides an operation start command to the controller 142 and turning off the main switch 148 provides an operation stop command to the controller 142.

As shown in FIG. 2, the fuel tank 114 and the fuel pump 128 are connected with each other by a pipe P1. The fuel pump 128 and the aqueous solution tank 116 are connected with each other by a pipe P2. The aqueous solution tank 116 and the aqueous solution pump 136 are connected with each other by a pipe P3. The aqueous solution pump 136 and the aqueous solution filter 134 are connected with each other by a pipe P4. The aqueous solution filter 134 and the cell stack 102 are connected with each other by a pipe P5. The pipe P5 is connected with an anode inlet I1 of the cell stack 102. By driving the aqueous solution pump 136, aqueous methanol solution is supplied to the cell stack 102. A voltage sensor 150 is provided near the anode inlet I1 of the cell stack 102 in order to detect concentration information, which reflects the concentration of aqueous methanol solution (the ratio of methanol in the aqueous methanol solution) supplied to the cell stack 102, using an electrochemical characteristic of the aqueous methanol solution. The voltage sensor 150 detects an open-circuit voltage of the fuel cell (fuel cells) 104, and the detected voltage value defines electrochemical concentration information. Based on the concentration information, the controller 142 detects the concentration of the aqueous methanol solution supplied to the cell stack 102. Near the anode inlet I1 of the cell stack 102, a temperature sensor 152 is provided as a temperature detecting device for detecting the temperature of aqueous methanol solution supplied to the cell stack 102.

The cell stack 102 and the aqueous solution radiator 108a are connected with each other by a pipe P6, and the radiator 108a and the aqueous solution tank 116 are connected with each other by a pipe P7. The pipe P6 is connected with an anode outlet I2 of the cell stack 102.

The pipes P1 through P7 serve primarily as a flow path for fuel.

The air filter 132 and the air chamber 140 are connected with each other by a pipe P8. The air chamber 140 and the air pump 138 are connected with each other by a pipe P9, the air pump 138 and the rust prevention valve 144 are connected with each other by a pipe P10 whereas the rust prevention valve 144 and the fuel cell stack 102 are connected with each other by a pipe P11. The pipe P11 is connected with a cathode inlet I3 of the cell stack 102. When the fuel cell system 100 generates power, the rust prevention valve 144 is opened. By driving the air pump 138 under this condition, air (gas) containing oxygen is introduced from outside. The rust prevention valve 144 is closed when the fuel cell system 100 is stopped to prevent backflow of water vapor into the air pump 138, and thereby prevent rusting of the air pump 138. An ambient temperature sensor 154 is provided near the air filter 132 to detect an ambient temperature.

The cell stack 102 and the gas-liquid separation radiator 108b are connected with each other by a pipe P12. The radiator 108b and the water tank 118 are connected with each other by a pipe P13. The water tank 118 is provided with a pipe (an exhaust pipe) P14.

The pipes P8 through P14 serve primarily as a flow path for oxidizer.

The water tank 118 and the water pump 146 are connected with each other by a pipe P15 whereas the water pump 146 and the aqueous solution tank 116 are connected with each other by a pipe P16.

The pipes P15, P16 serve as a flow path for water.

The aqueous solution tank 116 and the catch tank 130 are connected with each other by pipes P17, P18. The catch tank 130 and the air chamber 140 are connected with each other by a pipe P19.

The pipes P17 through P19 define a flow path primarily for fuel processing.

Next, reference will be made to FIG. 3, to cover an electrical configuration of the fuel cell system 100.

The controller 142 of the fuel cell system 100 preferably includes a CPU 156 for performing necessary calculations and controlling operations of the fuel cell system 100; a clock circuit 158 for providing the CPU 156 with a current time; a memory 160 provided by, e.g., an EEPROM for storing programs and data arranged to control the operations of the fuel cell system 100 as well as calculation data, etc.; a voltage detection circuit 164 for detecting a voltage in an electric circuit 162 to connect the cell stack 102 with an electric motor 40 which drives the motorbike 10; an electric current detection circuit 166 for detecting an electric current which passes through the fuel cells 104, i.e., the cell stack 102; an ON/OFF circuit 168 for opening and closing the electric circuit 162; a diode 170 provided in the electric circuit 162; and a power source circuit 172 for providing the electric circuit 162 with a predetermined voltage.

The CPU 156 of the controller 142 as described above is supplied with detection signals from the level sensors 120, 122 and 124, detection signals from the voltage sensor 150, the temperature sensor 152 and the ambient temperature sensor 154, and detection signals from the charge amount detector 46. The CPU 156 detects the amount of liquid in each of the tanks, based on relevant detection signals from the level sensors 120, 122 and 124 which reflect respective liquid levels.

The CPU 156 is also supplied with input signals from the main switch 148 for turning ON or OFF the electric power, and input signals from the start button 30a and the stop button 30b in the input portion 28c.

Further, the CPU 156 is supplied with voltage values detected by the voltage detection circuit 164 and electric current values detected by the electric current detection circuit 166. The CPU 156 calculates an output from the cell stack 102, using the voltage values and electric current values supplied thereto.

The CPU 156 controls system components such as the fuel pump 128, the aqueous solution pump 136, the air pump 138, the water pump 146, the fans 110, 112, and the rust prevention valve 144. For example, the CPU 156 controls the water pump 146 so that its output (the amount of water supply per unit time) is constant. The CPU 156 also controls the display 28b which displays various kinds of information for the driver of the motorbike 10. Further, the CPU 156 controls the ON/OFF circuit 168. When the ON/OFF circuit 168 is turned on, the electric circuit 162 is closed and electric power is taken out of the cell stack 102.

The cell stack 102 is connected with the secondary battery 126 and the drive unit 42. The secondary battery 126 and the drive unit 42 are connected with the electric motor 40. The secondary battery 126 complements the output from the cell stack 102 by being charged with electric power from the cell stack 102 and discharging the electricity to supply power to the electric motor 40, the system components, etc.

The electric motor 40 is connected with the meter 28a arranged to measure various data concerning the electric motor 40. The data and status information of the electric motor 40 obtained by the meter 28a are supplied to the CPU 156 via the interface circuit 176.

In addition, a charger 200 is connectable with the interface circuit 176. The charger 200 is connectable with an external power source (commercial power source) 202. While the external power source 202 is connected with the interface circuit 176 via the charger 200, an external power source connection signal is sent to the CPU 156 via the interface circuit 176. The charger 200 has a switch 200a which can be turned ON/OFF by the CPU 156.

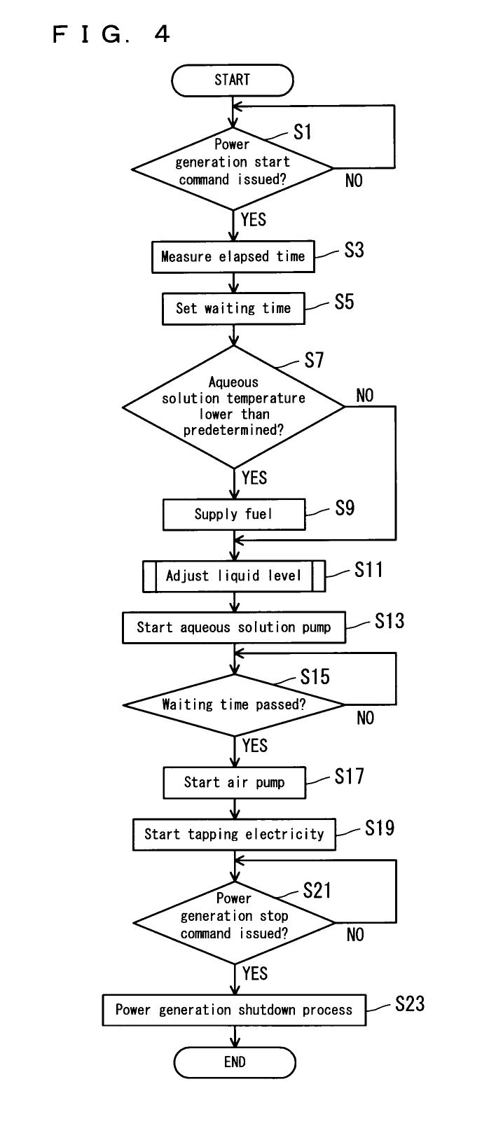

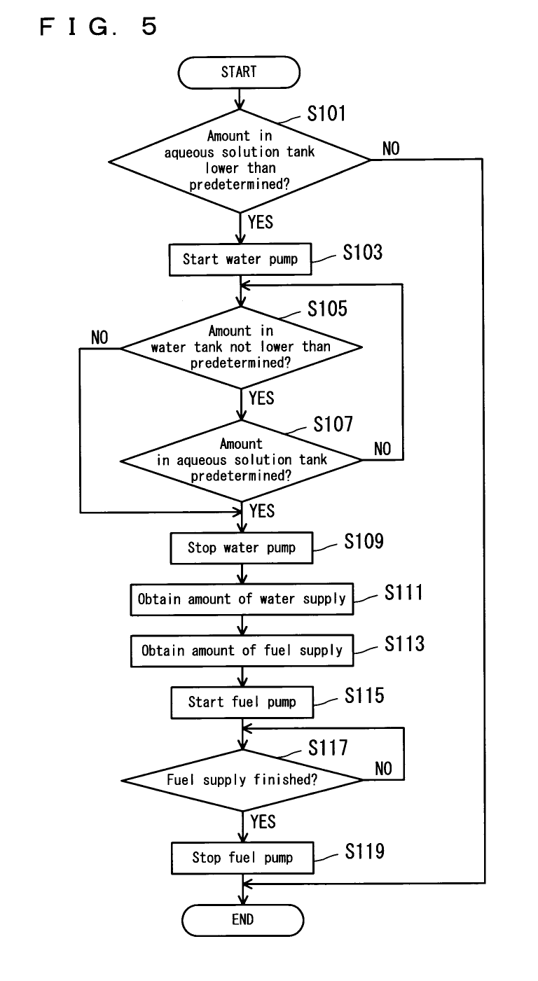

The memory device, i.e., the memory 160 stores programs for performing operations shown in FIG. 4 and FIG. 5, conversion information for converting electrochemical concentration information (open-circuit voltage) obtained by the voltage sensor 150 into a concentration, and calculation data, etc.

In the present preferred embodiment, the CPU 156 defines the first through the third controllers, and the start button 30a defines the instruction device. The CPU 156 also functions as the instruction device. The water supply amount obtaining device includes the CPU 156. The setting device includes the CPU 156. The circulation device includes the pipes P3 through P7, the aqueous solution tank 116 and the aqueous solution pump 136. The tapping device includes the electric circuit 162 and the ON/OFF circuit 168. The first and the second-time measuring devices include the CPU 156 and the clock circuit 158. The water supply device includes the water pump 146. The fuel supply device includes the fuel pump 128. The ON/OFF circuit 168 defines the switching device.

Next, description will cover a basic operation of the fuel cell system 100.

When the main switch 148 is turned on, the fuel cell system 100 starts the controller 142 and commences its operation. After the controller 142 is started, and when the amount of charge in the secondary battery 126 becomes not greater than a predetermined amount (for example, the charge rate becomes not greater than about 40%), the CPU 156 issues a power generation start command to itself. Thereafter, the system components such as the aqueous solution pump 136 and the air pump 138 are driven with electricity from the secondary battery 126, and thus power generation is started in the cell stack 102.

After the power generation is started, the CPU 156 automatically stops power generation in the cell stack 102 when the secondary battery 126 has been fully charged. In other words, the CPU 156 issues a power generation stop command to itself, and stops power generation in the cell stack 102 automatically. Thereafter, the CPU 156 starts (resumes) power generation in the cell stack 102 when the amount of the charge in the secondary battery 126 becomes not greater than the predetermined amount. In other words, the CPU 156 issues a power generation start command to itself, thereby resuming power generation in the cell stack 102 automatically.

A power generation start command is also issued to the CPU 156 when the start button 30a is pressed after the controller 142 is started. Also, a power generation stop command is issued to the CPU 156 when the stop button 30b is pressed during power generation.

Referring now to FIG. 2, aqueous methanol solution in the aqueous solution tank 116 is sent via the pipes P3, P4 to the aqueous solution filter 134 as the aqueous solution pump 136 is driven. The aqueous solution filter 134 removes impurities and so on from the aqueous methanol solution, then the aqueous methanol solution is sent through the pipe P5 and the anode inlet I1, directly to the anode 104b in each of the fuel cells 104 which define the cell stack 102.

Meanwhile, gas (primarily containing carbon dioxide, vaporized methanol and water vapor) in the aqueous solution tank 116 is supplied via the pipe P17 to the catch tank 130. The methanol vapor and water vapor are cooled in the catch tank 130, and the aqueous methanol solution obtained in the catch tank 130 is returned via the pipe P18 to the aqueous solution tank 116. On the other hand, gas (containing carbon dioxide, non-liquefied methanol and water vapor) in the catch tank 130 is supplied via the pipe P19 to the air chamber 140.

On the other hand, as the air pump 138 is driven, air is introduced through the air filter 132 and flows through the pipe P8 into the air chamber 140 where noise is silenced. The air which is introduced to the air chamber 140 and gas from the catch tank 130 flow via the pipe P9 to the air pump 138, and then through the pipe P10, the rust prevention valve 144, the pipe P11 and the cathode inlet I3, into the cathode 104c in each of the fuel cells 104 which define the cell stack 102.

At the anode 104b in each fuel cell 104, methanol and water in the supplied aqueous methanol solution chemically react with each other to produce carbon dioxide and hydrogen ions. The produced hydrogen ions flow to the cathode 104c via the electrolyte film 104a, and electrochemically react with oxygen in the air supplied to the cathode 104c, to produce water (water vapor) and electric energy. Thus, power generation is performed in the cell stack 102. The electricity from the cell stack 102 is used to charge the secondary battery 126, to drive the motorbike 10 and so on. The temperature of the cell stack 102 is increased by the heat associated with the electrochemical reactions. The output of the cell stack 102 increases as the temperature rises, and the cell stack 102 becomes able to perform normal constant power generation at approximately 50° C. The temperature of the cell stack 102 can be checked by the temperature of the aqueous methanol solution detected by the temperature sensor 152.

The temperatures of carbon dioxide produced at the anode 104b in each fuel cell 104 and of the aqueous methanol solution which includes unused methanol are increased by the heat associated with the electrochemical reaction. The carbon dioxide and the aqueous methanol solution flow from the anode outlet I2 of the cell stack 102, through the pipe P6 into the radiator 108a, where they are cooled. The cooling of the carbon dioxide and the methanol is facilitated by driving the fan 110. The carbon dioxide and the aqueous methanol solution which have been cooled then flow through the pipe P7, and return to the aqueous solution tank 116. In other words, driving of the aqueous solution pump 136 provides the circulating supply of the aqueous methanol solution which is held in the aqueous solution tank 116 and in the pipes P3 through P7 to the cell stack 102.

During power generation, bubbles are produced in the aqueous methanol solution in the aqueous solution tank 116 due to the return flow of carbon dioxide and aqueous methanol solution from the cell stack 102, the supply flow of methanol fuel from the fuel tank 114, and supply flow of water from the water tank 118. The float of the level sensor 122 moves up with the bubbles, and therefore the liquid level detected by the level sensor 122 during power generation is higher than the actual liquid level of the aqueous methanol solution. In other words, the amount of the liquid in the aqueous solution tank 116 is recognized as being greater than the actual amount of the liquid during power generation.

Meanwhile, most of the water vapor produced on the cathode 104c in each fuel cell 104 is liquefied and discharged in the form of water from the cathode outlet I4 of the cell stack 102, with saturated water vapor being discharged in the form of gas. The water vapor which is discharged from the cathode outlet I4 is supplied via the pipe P12 to the radiator 108b, where it is cooled and its portion is liquefied as its temperature decreases to or below the dew point. The liquefying operation of the water vapor by the radiator 108b is facilitated by operation of the fan 112. Discharge from the cathode outlet I4, which contains water (liquid water and water vapor), carbon dioxide and unused air, is supplied via the pipe P12, the radiator 108b and the pipe P13, to the water tank 118 where water is collected, and thereafter, discharged to the outside via the pipe P14.

At the cathode 104c in each fuel cell 104, the vaporized methanol from the catch tank 130 and methanol which has moved to the cathode 104c due to crossover react with oxygen in the platinum catalyst layer, thereby being decomposed to harmless water and carbon dioxide. The water and carbon dioxide which are produced from the methanol are discharged from the cathode outlet I4, and supplied to the water tank 118 via the radiator 108b. Further, water which has moved due to water crossover to the cathode 104c in each fuel cell 104 is discharged from the cathode outlet I4, and supplied to the water tank 118 via the radiator 108b.

The water in the water tank 118 is recycled appropriately by a pumping operation of the water pump 146, through the pipes P15, P16 to the aqueous solution tank 116. Also, methanol fuel in the fuel tank 114 is supplied appropriately by a pumping operation of the fuel pump 128, through the pipes P1, P2, to the aqueous solution tank 116.

Next, a main operation of the fuel cell system 100 will be described with reference to FIG. 4.

First, when the amount of charge in the secondary battery 126 becomes not greater than a predetermined amount or the start button 30a is pressed, to give the CPU 156 a power generation start command in Step S1, the CPU 156 measures the amount of time from the previous power generation shutdown to the current power generation start command (Step S3).

In Step S3, the amount of time from the previous power generation shutdown to the current power generation start command (hereinafter called elapsed time) is obtained by the CPU 156 by calculating a difference between the previous power generation shutdown time which is recorded in the memory 160 and the power generation start command issuance time which is obtained from the clock circuit 158.

Next, an amount of time from a moment when the aqueous solution pump 136 is started to a moment when the ON/OFF circuit 168 will be turned on is set based on the elapsed time (Step S5). In other words, an amount of time from a moment when the circulating supply of aqueous methanol solution is started to a moment when tapping of electricity will be started (hereinafter called waiting time) is set.

In Step S5, the CPU 156 sets the waiting time based on a predetermined threshold value (two hours, for example) stored in the memory 160 and the elapsed time obtained in Step S3. For example, if the elapsed time is smaller than the predetermined threshold value, then the waiting time is set to 30 seconds, for example, while if the elapsed time is not smaller than the predetermined threshold value, then the waiting time is set to 60 seconds (one minute), for example.

For the sake of reference, these two waiting time settings (30 seconds and 1 minute) are calculated in advance based on the output (the amount of aqueous solution supplied per unit time) of the aqueous solution pump 136 and the amount of aqueous methanol solution to be provided for the circulating supply, and are stored in the memory 160. With the waiting time set to 30 seconds, and the amount of aqueous methanol solution in the aqueous solution tank 116 being a predetermined amount (500 cc, for example), it is possible to circulate aqueous methanol solution in the pipes P3 through P7, the aqueous solution tank 116, etc. one time. With the waiting time set to one minute, it is possible to circulate the aqueous methanol solution two times. If the output of the aqueous solution pump 136 is doubled for example, these two waiting time settings will obviously be halved respectively.

Next, the CPU 156 determines whether or not the temperature of the aqueous methanol solution is lower than a predetermined temperature (about 45° C., for example), based on a detected result by the temperature sensor 152 (Step S7). If the temperature of the aqueous methanol solution is lower than the predetermined temperature, the fuel pump 128 is driven to supply methanol fuel from the fuel tank 114 to the aqueous solution tank 116 so as to increase the concentration of the aqueous methanol solution (approximately to 5 wt %, for example) (Step S9). Such a process as this is performed in order to increase the temperature of the aqueous methanol solution, i.e., the temperature of the cell stack 102 quickly, following the start of power generation.

Next, a liquid amount adjusting process is performed in order to bring the amount of liquid in the aqueous solution tank 116 to a predetermined amount (500 cc, for example) (Step S11). If Step S7 determines that the temperature of the aqueous methanol solution is not lower than the predetermined temperature, the process skips Step S9 and goes to Step S11.

Now, reference will be made to FIG. 5 to provide detailed description of the liquid amount adjusting process in Step S11.

First, the CPU 156 determines whether or not the amount of the aqueous methanol solution in the aqueous solution tank 116 is lower than a predetermined amount (500 cc, for example), based on a detection signal from the level sensor 122 (Step S101). If the amount of aqueous methanol solution in the aqueous solution tank 116 is lower than the predetermined amount, the CPU 156 starts the water pump 146 (Step S103). The CPU 156 obtains the time at this point from the clock circuit 158, and records the time in the memory 160 as a driving start time of the water pump 146.

Next, the CPU 156 determines whether or not the amount of liquid in the water tank 118 is not lower than a predetermined amount (100 cc, for example) based on a detection signal from the level sensor 124 (Step S105). If the amount of liquid in the water tank 118 is not lower than the predetermined amount, the CPU 156 continues to drive the water pump 146 until the amount of liquid in the aqueous solution tank 116 reaches the predetermined amount (as long as Step S107 determines NO).

Then, when Step S107 determines that the amount of liquid in the aqueous solution tank 116 has reached the predetermined amount, the CPU 156 stops the water pump 146 (Step S109). The CPU 156 obtains the time at this point from the clock circuit 158, and records the time in the memory 160 as a driving stop time of the water pump 146. If Step S105 determines that the amount of liquid in the water tank 118 has become lower than the predetermined amount, the process also goes to Step S109.

During power generation, as described earlier, bubbles are produced in the aqueous methanol solution in the aqueous solution tank 116, and the amount of liquid in the aqueous solution tank 116 is brought to be the predetermined amount based on the level of liquid which contains the bubbles. Since the bubbles disappear after power generation is stopped, the float position in the level sensor 122 after stopping power generation becomes much lower than the position which represents the predetermined amount. In other words, the liquid level after power generation is stopped is much lower than the position which represents the predetermined amount. For this reason, commonly in the first liquid amount adjusting process, a large amount of water is supplied to the aqueous solution tank 116 between Steps S103 to S109.

Next, the CPU 156 calculates a difference between the driving start time and the driving stop time of the water pump 146 recorded in the memory 160. In other words, the time for which the water pump 146 was driven is calculated. Then, using this time and the output of the water pump 146, the CPU 156 obtains the amount of water which was supplied to the aqueous solution tank 116 (Step S111).

As described earlier, the water pump 146 is controlled so that its output (the amount of water supplied per unit time) is constant. Thus, in Step S111, the supplied amount of water is obtained by multiplying the driving time of the water pump 146 by the amount of water supplied (output) per unit time of the water pump 146.

Next, the CPU 156 calculates the amount of methanol fuel necessary to make the aqueous methanol solution of a desired concentration from the calculated amount of water which has been supplied, and stores a result of the calculation in the memory 160 as the amount of methanol fuel to be supplied. In other words, the amount of the methanol fuel supply is obtained (Step S113).

Next, the CPU 156 starts the fuel pump 128 (Step S115), to start supplying methanol fuel to the aqueous solution tank 116. Thereafter, when Step S117 determines that the amount of methanol fuel determined in Step S113 has been supplied, the fuel pump 128 is stopped (Step S119), and the liquid amount adjusting process comes to an end.

Returning to FIG. 4, Step S11 is followed by starting of the aqueous solution pump 136 (Step S13), whereby the circulating supply of the aqueous methanol solution stored in the aqueous solution tank 116 and in the pipes P3 through P7 to the cell stack 102 is started. Then, when Step S15 determines that the waiting time, which was set in Step S5 and is a time since the start of circulating the supply, has elapsed, the CPU 156 starts the air pump 138 (Step S17) to start power generation in the cell stack 102. Along with this, the CPU 156 turns on the ON/OFF circuit 168 to start tapping electricity from the cell stack 102 via the electric circuit 162 (Step S19). It should be noted here that after Step S19, the liquid amount adjusting process shown in FIG. 5 is performed at a regular interval (about every 10 seconds, for example).

Thereafter, if Step S21 determines that the secondary battery 126 has been fully charged or the stop button 30b has been pressed to issue the power generation stop command to the CPU 156, then a power generation stopping procedure is performed (Step S23).

In Step S23, the aqueous solution pump 136 and the air pump 138 are stopped to stop power generation in the cell stack 102. Then, the time at which the aqueous solution pump 136 and the air pump 138 were stopped is recorded in the memory 160 as a previous power generation shutdown time.

According to the fuel cell system 100 as described, tapping of electricity from the cell stack 102 is started after circulating the supply is started, whereby it becomes possible to agitate the aqueous methanol solution before starting the tapping of electricity, and to reduce the concentration non-uniformity in the aqueous methanol solution. By starting the tapping of electricity after having reduced the concentration non-uniformity in the aqueous methanol solution as described, it becomes possible to stabilize the output from the cell stack 102.

If tapping of electricity from the cell stack 102 is started without correcting the concentration non-uniformity in the aqueous methanol solution, the electrolyte film 104a deteriorates at an accelerated pace. Deterioration of the electrolyte film 104a is a cause of decreased output of the cell stack 102 or shortened life of the cell stack 102. According to the fuel cell system 100, it is possible to reduce deterioration of the electrolyte film 104a by starting the tapping of electricity after the concentration non-uniformity in the aqueous methanol solution has been reduced, which makes it possible to reduce a decrease in the output of cell stack 102 or shortening of the life of cell stack 102. As exemplified in the operation in FIG. 4, it is possible to reduce deterioration of the electrolyte film 104a more effectively by reducing the concentration non-uniformity in the aqueous methanol solution before driving the air pump 138 (before starting power generation). It should be noted here that, deterioration of the electrolyte film 104a can be reduced also by pausing the tapping of electricity after power generation has been started because electrochemical reactions stop until power is taken from the cell stack 102, once an amount of electric energy has been produced.

By controlling the timing for the tapping of electricity based on the amount of time since circulating the supply is started, it becomes easier to control the timing than, for example, controlling the timing for the tapping of electricity based on the level of the concentration non-uniformity which can be obtained through concentration detection made at a plurality of locations between the pipes P3 through P7.

By starting the tapping of electricity after the lapse of the waiting time which is set based on the amount of time since the previous power generation shutdown to the current power generation starting command, it becomes possible to start the tapping of electricity from the cell stack 102 at a timing appropriate to the concentration non-uniformity of the aqueous methanol solution.

By turning on the ON/OFF circuit 168 after starting circulating the supply of aqueous methanol solution, it becomes possible to agitate the aqueous methanol solution before starting the tapping of electricity and thus to reduce concentration non-uniformity in the aqueous methanol solution.

Water is added to the aqueous solution tank 116 in order to bring the amount of liquid to a predetermined level, then circulating the supply of the aqueous methanol solution is started, and thereafter electric power is taken from the cell stack 102. Therefore, it is possible to stabilize the output from the cell stack 102 even in a case where water is added to the aqueous solution tank 116 before starting circulating the supply of aqueous methanol solution. Also, methanol fuel is added to the aqueous solution tank 116 in order to raise the temperature of the cell stack 102 quickly, then circulating the supply of aqueous methanol solution is started, and thereafter electric power is taken from the cell stack 102. Therefore, it is possible to stabilize the output from the cell stack 102 even in a case where methanol fuel is added to the aqueous solution tank 116 before starting circulating the supply of aqueous methanol solution.

Since it is possible, through the liquid amount adjusting process, to supply the aqueous solution tank 116 with an amount of methanol fuel which is appropriate to the supplied amount of water, it becomes possible to reduce the concentration change in the aqueous methanol solution caused by the water supplied to the aqueous solution tank 116, and thereby to further stabilize the output from the cell stack 102. Since it is possible to supply methanol fuel according to the supplied amount of water, it is now possible to reduce the concentration change in the aqueous methanol solution reliably even if a large amount of water has been supplied to the aqueous solution tank 116 due to the use of a float-type level sensor 122.

According to preferred embodiments of the present invention, it is possible to reduce the concentration non-uniformity in the aqueous methanol solution. Therefore, preferred embodiments of the present invention can be used suitably for relatively large fuel cell systems which have an output capacity not lower than about 100 W, i.e., the systems in which it is difficult to reduce the concentration non-uniformity.

Desirably, a motorbike 10 should be able to run stably. The fuel cell system 100 is capable of stabilizing the output from the cell stack 102, quickly achieving and maintaining a high output, and quickly driving the system components stably. Therefore, the fuel cell system 100 can be used suitably for transportation equipment such as a motorbike 10.

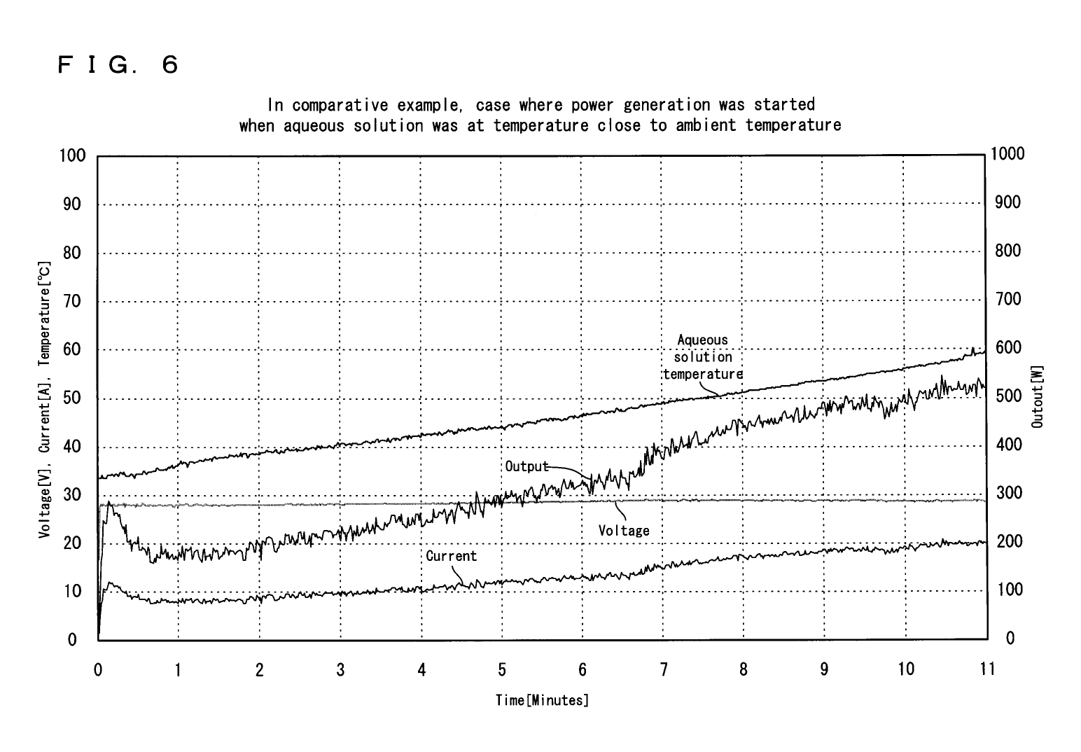

Now, reference will be made to FIG. 6 through FIG. 9 to compare the fuel cell system 100 with another fuel cell system (hereinafter called comparative example) in terms of timecourse changes in their cell stack output, voltage and current, as well as the temperature of the aqueous methanol solution (cell stack).

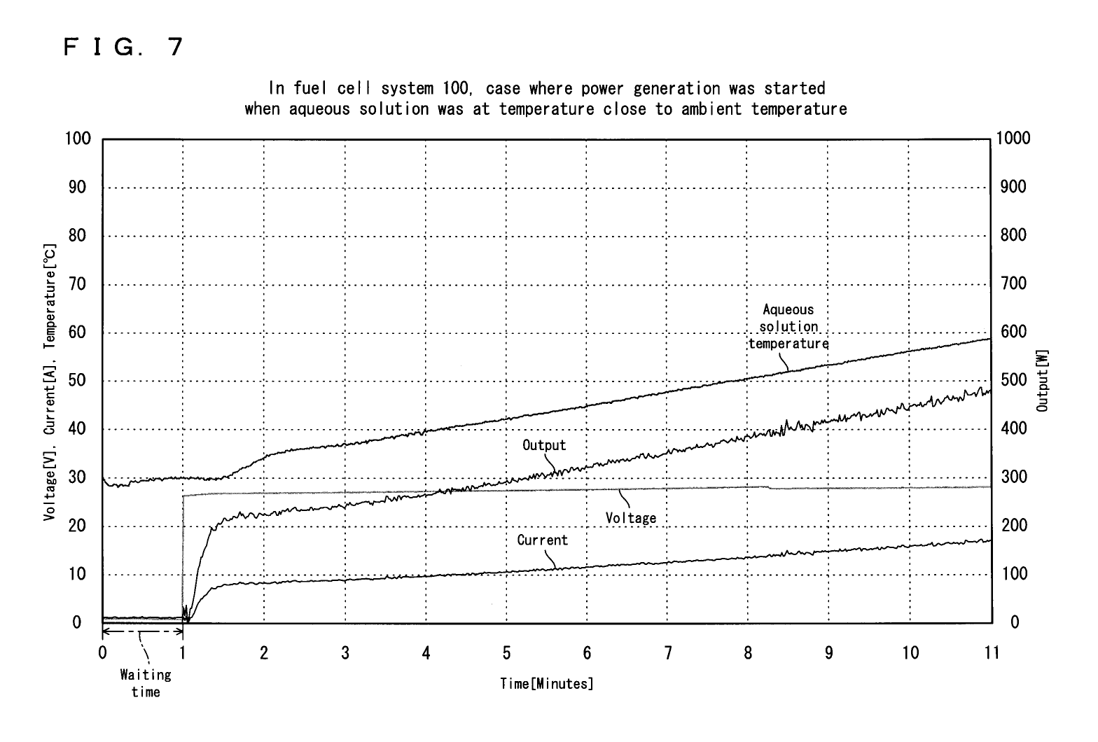

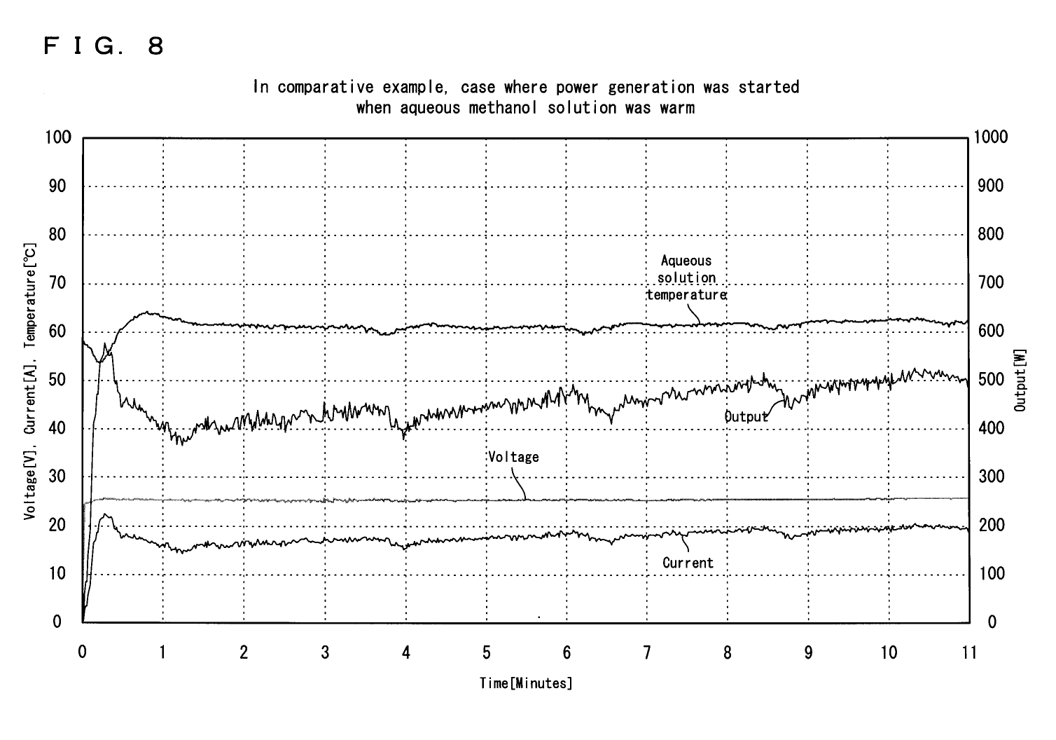

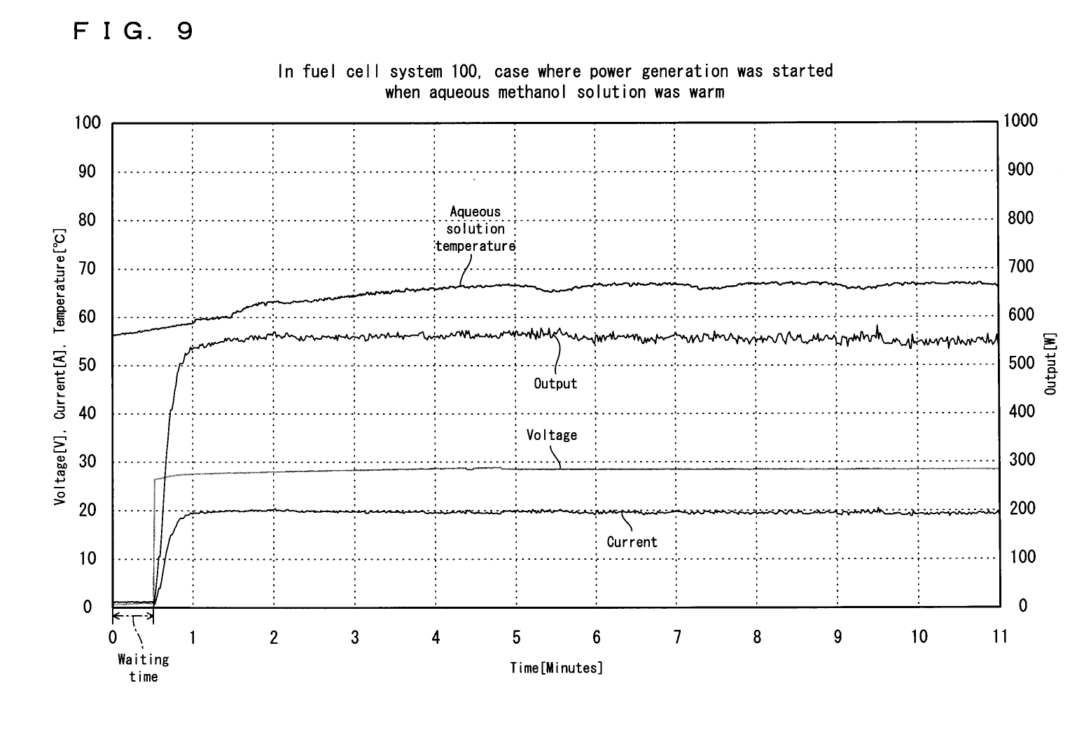

FIG. 6 and FIG. 7 show timecourse changes of the output, etc. in a case where power generation was started when the aqueous methanol solution was at a temperature close to an ambient temperature. FIG. 6 shows changes in the comparative example whereas FIG. 7 shows changes in the fuel cell system 100. FIG. 8 and FIG. 9 show timecourse changes in a case where, for example, power generation in the cell stack was stopped temporarily, and a load (an electric motor) was driven by electricity from the secondary battery, and then power generation in the cell stack was started (resumed) as the amount of charge in the secondary battery (charge rate) decreased. In other words, these figures show timecourse changes in a case where power generation was started when the temperature of the aqueous methanol solution was higher than a normally anticipated ambient temperature. FIG. 8 shows timecourse changes in the comparative example whereas FIG. 9 shows timecourse changes in the fuel cell system 100.

FIG. 6 and FIG. 8 show timecourse changes of various measurements since power generation was started in the comparative example. On the other hand, FIG. 7 and FIG. 9 show timecourse changes of various measurements since the aqueous solution pump 136 was started in the fuel cell system 100.

In the comparative example, tapping of electricity was started at the same time as the aqueous solution pump and the air pump were started. In other words, tapping of electricity was started simultaneously with the start of power generation. In the comparative example, a liquid amount adjusting process was performed in five seconds after the power generation was started, in both of the case where the aqueous methanol solution was approximately at an ambient temperature and the case where aqueous methanol solution was warm. Thereafter, the liquid amount adjusting process was performed every ten seconds. The liquid amount adjusting process (supplying of water) performed in the comparative example was different from the liquid amount adjusting process (see FIG. 5) in that it did not include such a process that methanol fuel was supplied according to the supplied amount of water. In the fuel cell system 100, the liquid amount adjusting process was performed before starting circulating the supply as described earlier, and the liquid amount adjusting process was performed about every 10 seconds after tapping of the electricity was started.

In both the fuel cell system 100 and the comparative example, methanol fuel was supplied based on the amount of methanol consumption by the cell stack, until about ten minutes passed since the start of power generation. After the lapse of about ten minutes from the start of power generation, methanol fuel was supplied based on the concentration of the aqueous methanol solution detected by the voltage sensor.

Now, first, comparison between the fuel cell system 100 and the comparative example will be made where power generation was started when the temperature of the aqueous methanol solution was approximately at an ambient temperature.

As shown in FIG. 6, in the comparative example, the concentration of the aqueous methanol solution supplied to the cell stack was not uniform, and therefore the current, i.e., the output fluctuated over a range and was not stable. Also, since a large amount of water was supplied in the first liquid amount adjustment, the concentration of the aqueous methanol solution decreased drastically, resulting in a drastic decrease in the current, i.e., the output right after the tapping of electricity.

On the other hand, as shown in FIG. 7, in the fuel cell system 100, circulating the supply of aqueous methanol solution was performed for about one minute before tapping of electricity was started. Since this makes it possible to reduce the concentration non-uniformity in the aqueous methanol solution, the system was able to reduce the fluctuation in the current, i.e., the output, and to increase the output more stably than the comparative example. Also, the fuel cell system 100 was able to reduce a concentration drop in the aqueous methanol solution through the supply of methanol fuel according to the supplied amount of water, and was able to prevent a decrease in output caused by the supply of water.

Next, comparison between the fuel cell system 100 and the comparative example will be made where power generation was started when the temperature of the aqueous methanol solution was high.

As shown in FIG. 8, in the comparative example, the concentration of aqueous methanol solution supplied to the cell stack was not uniform just as in the case where aqueous methanol solution was approximately at an ambient temperature. Thus, the output fluctuated over a range and was not stable. Also, since methanol fuel was not supplied according to the supply of water, the current, i.e., the output dropped from time to time, and the system was not able to maintain its output at a level not lower than about 500 W until ten minutes have passed since the power generation was started.

On the other hand, as shown in FIG. 9, in the fuel cell system 100, circulating the supply of aqueous methanol solution was performed for about 30 seconds before the tapping of electricity was started. Through this, the system was able to reduce the fluctuation in the output better than the comparative example, just as in the case when the aqueous methanol solution was approximately at an ambient temperature. Also, the fuel cell system 100 was able to reduce a decrease in the output through the supply of methanol fuel according to the supplied amount of water, and was able to maintain a stable output.

From comparison between FIG. 7 and FIG. 9 in terms of the waiting time, it is confirmed that the system works effectively enough even if the waiting time is shortened, as long as the time elapsed from the previous power generation shutdown is short.

As exemplified, the fuel cell system 100 demonstrated that whether aqueous methanol solution was approximately at an ambient temperature or warm, the system was able to increase its output more straightly toward stable operation than the comparative example.

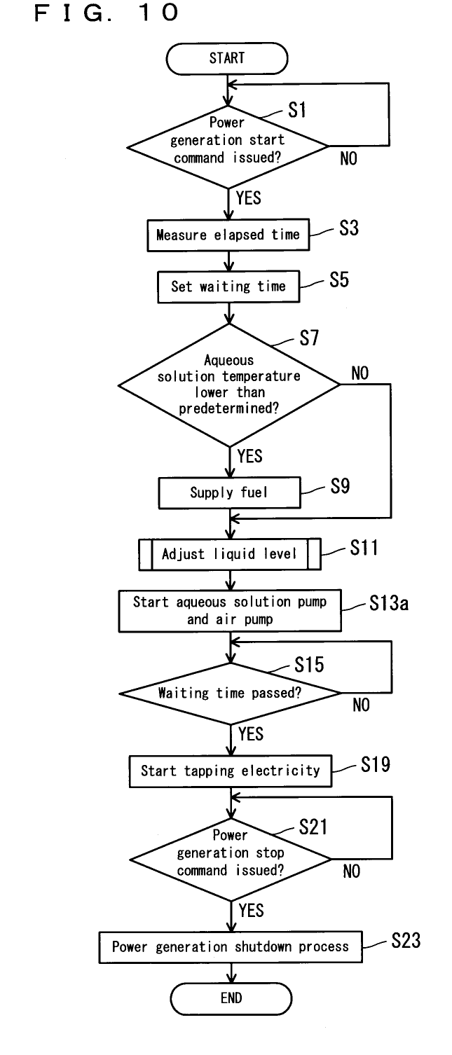

It should be noted here that in the operation in FIG. 4, the air pump 138 is not driven until the waiting time has elapsed. However, preferred embodiments of the present invention are not limited to this. For example, an operation in FIG. 10 may be performed. The operation in FIG. 10 is to start driving the aqueous solution pump 136 and the air pump 138 simultaneously. In the operation in FIG. 10, those processes identical with the processes in the operation in FIG. 4 are indicated by the same reference codes as in the operation in FIG. 4, and their description will not be repeated here.

In the operation in FIG. 10, the aqueous solution pump 136 and the air pump 138 are started simultaneously after Step S11 (Step S13a). In other words, power generation in the cell stack 102 is started at the same time as circulating the supply of aqueous methanol solution is started. Thereafter, when Step S15 determines that the time since the aqueous solution pump 136 was started (the time since circulating the supply was started) has exceeded the waiting time, the process goes to Step S19 to start tapping of electricity. By keeping the air pump 138 running as described, it becomes possible to discharge aqueous methanol solution, which moved to the cathode 104c in crossover phenomenon, from the cathode 104c before tapping of electricity is started, and therefore it becomes possible to further stabilize the output.

Also, in the operation in FIG. 4, description was made where the waiting time is set to one of two predetermined times (about 30 seconds or about one minute, in the present preferred embodiment) based on a result of comparison between the elapsed time and the predetermined threshold value (about two hours in the present preferred embodiment). However, the waiting time may be set in any method. For example, a table data which relates elapsed time with waiting time may be stored in the memory 160 so as to choose a waiting time which corresponds to the current elapsed time from the table data.

Further, in the operation in FIG. 4, description was made where an elapsed time is obtained as information regarding concentration non-uniformity of the aqueous methanol solution, and setting of the waiting time is based on the elapsed time. However, preferred embodiments of the present invention are not limited to this.

For example, the temperature of the aqueous methanol solution detected by the temperature sensor 152, which defines the temperature detection device, may be used as the information regarding concentration non-uniformity of the aqueous methanol solution. If the temperature of the aqueous methanol solution is high, it is presumed that the time from the previous power generation shutdown is short and concentration non-uniformity in the aqueous methanol solution is small. Also, if the temperature of the aqueous methanol solution is high, methanol can diffuse easily, so it is possible to quickly bring the aqueous methanol solution to a substantially uniform concentration. Therefore, the waiting time should be shortened when the temperature of the aqueous methanol solution is high, whereas the waiting time should be made long when the temperature of the aqueous methanol solution is low. Specifically, for example, the waiting time is set to about 30 seconds, for example, if the temperature of aqueous methanol solution is not lower than about 50° C., for example, whereas the waiting time is set to about one minute, for example, if the temperature of aqueous methanol solution is lower than about 50° C.

Also, setting of the waiting time may be made based on the temperature of the aqueous methanol solution and the elapsed time. Specifically, for example, the waiting time is set to about 30 seconds if the temperature of the aqueous methanol solution is not lower than about 50° C. and the elapsed time is shorter than about two hours, whereas the waiting time is set to about one minute in other cases.

It should be noted here that in the liquid amount adjusting process in FIG. 5, description was made where the supplied amount of water is obtained from the drive time and output of the water pump 146 in Step S111. However, the supplied amount of water may be obtained by any other method.

For example, the supplied amount of water may be obtained based on a result of detection of the amount of liquid in the aqueous solution tank 116. In this case, the amount of the aqueous methanol solution in the aqueous solution tank 116 is detected by using the level sensor 122 before driving the water pump 146 and also after stopping the water pump 146, and a difference between these is obtained as the supplied amount of water to the aqueous solution tank 116. By using the amount of increase of the liquid in the aqueous solution tank 116 resulting from the supply of water to define the supplied amount of water, it becomes possible to obtain the supplied amount of water more accurately.

Also, the supplied amount of water may be obtained based on a result of detection of the amount of liquid (amount of water) in the water tank 118. In this case, the amount of liquid in the water tank 118 is detected by using the level sensor 124 before driving the water pump 146 and also after stopping the water pump 146, and a difference between these is obtained as the amount of water supplied to the aqueous solution tank 116. By using the amount of decrease of the amount of liquid in the water tank 118 resulting from the supply of water to define the supplied amount of water, it becomes possible to obtain the supplied amount of water more accurately.

Further, the supplied amount of water may be obtained before supplying the water, through a calculation of a difference between the amount of liquid in the aqueous solution tank 116 detected by the level sensor 122 before the water is supplied and a predetermined amount (about 500 cc in the present preferred embodiment). In this case, the supplied amount of methanol fuel may be set based on this supplied amount of water before supplying the water is started, and the supply of methanol fuel to the aqueous solution tank 116 may be started by the time the supply of water is finished.

Also, in the liquid amount adjusting process in FIG. 5, the target concentration (desired concentration) of aqueous methanol solution may be a fixed concentration, or the target may be varied depending on the operation condition of the fuel cell system 100.

In the liquid amount adjusting process in FIG. 5, description was made where the CPU 156 obtains the supplied amount of fuel based on the supplied amount of water, and the fuel pump 128 is controlled so as to supply the obtained amount of methanol fuel. However, the method of controlling the fuel pump 128 is not limited to this. For example, the driving time of the fuel pump 128 may be set based on the supplied amount of water, so that the fuel pump 128 is controlled based on this driving time.

Further, in the operation in FIG. 4, the liquid amount adjusting process may not be performed if the aqueous methanol solution is ready for power generation in the cell stack 102 before the liquid amount adjusting process in FIG. 5. For example, if the elapsed time is shorter than about two hours and the temperature of aqueous methanol solution is not lower than about 50° C., it is likely that the aqueous methanol solution has a uniform concentration, and there is no need for raising the temperature of the aqueous methanol solution, either. If the aqueous methanol solution is ready for power generation as described, it is possible to maintain the state of the aqueous methanol solution by not performing the liquid amount adjusting process, and it is possible to shift to normal operation quickly. Further, in this case, there is no need to decrease concentration non-uniformity of the aqueous methanol solution by circulating the supply, either. So, simply, the waiting time is set to zero seconds, and tapping of electricity may be started simultaneously as the aqueous solution pump 136 and the air pump 138 are started (as power generation is started).

Also, the operation in FIG. 4 maybe such that the aqueous solution pump 136 is driven to start circulating the supply of aqueous methanol solution, and thereafter the concentration adjustment is performed by adding water and methanol fuel while circulating the supply is performed, and thereafter electricity is tapped from the cell stack 102. With such an operation as the above, it becomes possible to stabilize the output from the cell stack 102, even in cases where water and methanol fuel are added after starting circulating the supply of aqueous methanol solution.

It should be noted here that, in the preferred embodiments given above, description was made where the CPU 156 functions as the first through the third controllers. However, preferred embodiments of the present invention are not limited to this. For example, the system may include a CPU which functions as the first controller, another CPU which functions as the second controller, and still another CPU which functions as the third controller.

It should be noted here that the fuel cell system according to preferred embodiments of the present invention are applicable not only to motorbikes but also to any transportation equipment such as automobiles and marine vessels.

In the preferred embodiment given above, description was made where methanol is used as the fuel, and aqueous methanol solution is used as the aqueous fuel solution. However, preferred embodiments of the present invention are not limited to this, and the fuel may be provided by other alcohol based fuels such as ethanol, and the aqueous fuel solution may be provided by an aqueous solution of the alcohol, such as an aqueous ethanol solution.

Also, preferred embodiments of the present invention are applicable to stationary type fuel cell systems as long as a liquid fuel is used. Further, preferred embodiments of the present invention are applicable to portable type fuel cell systems for electronic appliances such as personal computers and portable devices.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A fuel cell system comprising:
a fuel cell;
a circulation device arranged to circulate a supply of aqueous fuel solution to the fuel cell;
a tapping device arranged to take electricity out of the fuel cell; and
a first controller arranged to control the tapping device so as to start tapping electricity from the fuel cell after the circulation device starts circulating the supply of aqueous fuel solution.

2. The fuel cell system according to claim 1, further comprising a first time-measuring device arranged to measure a time since the circulation device started circulating the supply of aqueous fuel solution, wherein the first controller controls the tapping device based on a result of time measured by the first time-measuring device.

3. The fuel cell system according to claim 2, further comprising a setting device arranged to set a waiting time from a start of circulating the supply by the circulation device to a start of tapping of electricity by the tapping device, based on information regarding concentration non-uniformity of the aqueous fuel solution before circulating the supply, wherein the first controller controls the tapping device so as to start tapping electricity from the fuel cell after a result of time measured by the first time-measuring device has exceeded the waiting time.

4. The fuel cell system according to claim 3, further comprising:
an instruction device arranged to issue a power generation start command of the fuel cell; and
a second-time measuring device arranged to measure a time from a previous power generation shutdown to a current power generation starting command issued by the instruction device; wherein
the setting device sets the waiting time based on a result of time measured by the second-time measuring device as the information regarding concentration non-uniformity.

5. The fuel cell system according to claim 1, wherein the tapping device includes an electric circuit arranged to provide an electric connection between the fuel cell and a load; and
a switching device provided on the electric circuit arranged to select from a state where an electric current can flow between the fuel cell and the load and a state where an electric current cannot flow; wherein
the first controller controls the switching device so as to start tapping electricity from the fuel cell after the circulation device starts circulating the supply of aqueous fuel solution.

6. The fuel cell system according to claim 1, further comprising a water supply device arranged to supply water to the circulation device, and a second controller arranged to control the water supply device so as to supply the water to the circulation device before electricity is tapped from the fuel cell.

7. The fuel cell system according to claim 6, further comprising:
a fuel supply device arranged to supply the circulation device with fuel of a higher concentration than the aqueous fuel solution;
a water supply amount obtaining device arranged to obtain an amount of the water supplied to the circulation device by the water supply device; and
a third controller arranged to control the fuel supply device so as to supply the fuel to the circulation device based on the supplied amount of water obtained by the water supply amount obtaining device, before electricity is tapped from the fuel cell.

8. The fuel cell system according to claim 1, further comprising a fuel supply device arranged to supply the circulation device with fuel of a higher concentration than the aqueous fuel solution, and a third controller arranged to control the fuel supply device so as to supply the fuel to the circulation device before electricity is tapped from the fuel cell.

9. The fuel cell system according to claim 1, wherein the fuel cell system has an output not lower than about 100 W.

10. Transportation equipment comprising the fuel cell system according to claim 1.

11. A control method of a fuel cell system comprising:
a first step of starting circulating a supply of aqueous fuel solution to a fuel cell; and
a second step of starting tapping of electricity from the fuel cell after the first step.
